(19) United States
(12) Patent Application Publication
(10) Pub. No.: US 2010/0072078 A1
(43) Pub. Date: Mar. 25, 2010

(54) MICRO-DEVICE FOR ANALYSING LIQUID SAMPLES

(75) Inventors: Laurent Davoust, Requeil (FR); Jérôme Boutet, Grenoble (FR); Cyril Picard, Annecy-Le-Vieux (FR)

Correspondence Address: Nixon Peabody LLP, P.O. Box 60610, Palo Alto, CA, 94306, US

(73) Assignees: COMMISSARIAT A L'ENERGIE ATOMIQUE, Paris (FR); CENTRE NATIONAL DE LA RECHERCHE SCIENTIFIQUE, Paris (FR); INSTITUT POLYTECHNIQUE DE GRENOBLE, Grenoble (FR)

(21) Appl. No.: 12/564,860

(22) Filed: Sep. 22, 2009

(30) Foreign Application Priority Data
Sep. 23, 2008 (FR) 08 56390

(51) Int. Cl. G01N 27/26; C25B 9/00; C25B 11/00

(52) U.S. Cl. 205/687; 204/280; 204/242; 204/400; 205/775; 205/792

(57) ABSTRACT

A device for forming waves at the interface (I) of a liquid drop (F1) by electrowetting, enabling the micro-mixing and concentration of constituents at the interface (I) of the drop (F1). The device comprises at least one excitation electrode suitable for generating an oscillating and radial electric field about a first axis of symmetry, under the effect of an electric control, and a liquid drop (F1) arranged on said excitation electrode and having an axis of symmetry coinciding substantially with said first axis of symmetry, such that said electric field generates essentially axisymmetric waves at the interface (I) of said drop (F1).

### CROSS REFERENCE TO RELATED APPLICATIONS OR PRIORITY CLAIM

This application claims priority of French Patent Application No. 08 56390, filed Sep. 23, 2008.

### DESCRIPTION

1. Field of the Invention

The present invention relates to the general field of liquid sample analysis, particularly for detecting constituents potentially present in the sample.

It also relates to the field of discrete microfluidics in that the liquid sample to be analysed may be in drop form. In this case, the term drop refers to substantially hemispherical drops, pools or capillary bridges.

The invention particularly relates to a device for forming surface waves at the interface of a liquid drop by means of electrowetting.

The proposed invention has numerous applications for concentrating and detecting biological or chemical targets, the rheological characterisation of fluid samples, or movement transmission in microfluidics.

2. State of the Related Art

In numerous fields, it is desired to detect constituents potentially present in a liquid drop.

This may be the case, for example, to establish a biological or medical diagnosis, or in the field of genetic engineering or food processing. It may be desired to detect or assay, in particular, macromolecules, cells, analytes, organites, pathogens, intercalating substances.

This also applies in the field of the electronuclear industry, where it is essential to be able to detect the radioactive elements present in liquid effluents, particularly actinides which form, with plutonium, the most hazardous waste.

Environmental detection, more broadly, is intended to determine the concentration particularly of pathogens, metals, solid particles and colloids in liquids of interest.

In the majority of these fields, it is desired to analyse small-volume liquid samples in a short time as simply and as non-intrusively as possible.

Discrete (or digital) microfluidics makes it possible to handle and displace very small-volume drops. It plays an increasing role in the development of new micro-systems such as laboratories on a chip, and makes it possible to perform numerous analytical steps in sequence.

It is distinguished from continuous microfluidics (in channels) particularly by means of the option to do away with pumps, valves, walls required to confine the flow, etc. Parietal physicochemical contaminations can thus be minimized or even eliminated.

An illustration thereof includes biochips which form, in the field of molecular biology, systems for analysing the hybridisation of nucleic acids (DNA and/or RNA), or antigen/antibody, protein/ligand, protein/protein, enzyme/substrate type interaction, etc. In this case, the kinetic parameters or equilibrium constants associated with said chemical constants are required.

Biological molecules can be detected using PCR or ELISA techniques known to those skilled in the art. These techniques usually use the grafting of a probe molecule labelled with a fluorescent compound. The fluorescence level emitted is then measured using optical means to thus quantify the hybridisation process.

These detection techniques are generally preceded by preparation of the liquid sample to be analysed. The preparation may consist of mixing or stirring the liquid from the sample, and concentrating the biological molecules in a defined zone, for example at the fluid interface of the liquid sample.

An example of a device used to perform these preparation operations, to subsequently detect the biological molecules present in a drop, is described in patent application WO2008/068229 filed on behalf of the applicant.

This device makes it possible to generate a circulatory, or vortex, flow, inside the drop by means of electrohydrodynamics without inducing interfacial deformation or overall displacement of the drop. This vortex then produces a mixture of the liquid of the drop, by means of stirring or centrifugation, which makes it possible to accelerate the hybridisation kinetics while remaining compatible with miniaturization constraints. It also makes it possible to concentrate the constituents at the interface of the drop under the effect of a centrifugal force, for more sensitive detection.

To generate this vortex, the drop is placed on a dielectric layer covering two electrodes with zigzag-shaped edges, facing one another. The application of a difference in potential between said two electrodes gives rise to an oblique electric field with respect to the drop interface, due to the shape of the edges and the position of the drop. The tangential component of the electric field then causes the displacement of the electric charges accumulated at the interface, which, by means of viscosity, induces a liquid flow inside the drop.

This device thus makes it possible to mix the liquid from the drop and concentrate the constituents at the drop interface, thus enabling purification, extraction or more precise detection.

However, the device according to the prior art has a number of drawbacks.

The intensity of the vortex generated is dependent on that of the electric field. However, this intensity decreases significantly on moving away from the electrodes. Also, the vortex is substantially located in the vicinity of the electrodes. The mixture produced in the drop is thus not homogeneous, and the constituents are more concentrated in the vicinity of the electrodes and the triple line.

However, it may be desired to obtain a significant concentration at a distance from the contact line and electrode surface, for example at the apex of the drop, to thus avoid disturbances due to boundary conditions (triple line) and walls, and enable easier subsequent detection, which is not permitted by the device according to the prior art.

Moreover, the vortex only gives the required information on the constituents potentially present in the drop, such as the concentration thereof or the kinetic chemical or biological interaction parameters using complex velocity field display techniques, such as micro-PIV (Particle Image Velocimetry). In this case, it is necessary to use detection techniques (PCR, ELISA, etc.) making use of probe molecule labelling, resulting in a high cost and long processing time.

### DESCRIPTION OF THE INVENTION

The aim of the present invention is to propose a device for mixing the liquid from a drop and obtaining a significant concentration of the constituents potentially present at the interface in a zone of the interface at a substantial distance from the triple line of the drop.

For this purpose, the invention firstly relates to a device for forming waves at the interface of a liquid drop by electrowetting.

According to the invention, said device comprises at least one excitation electrode suitable for generating an oscillating and radial electric field about a first axis of symmetry, under the effect of an electric control, so that, in the presence of a liquid drop arranged on said excitation electrode and having an axis of symmetry coinciding substantially with said first axis of symmetry, said electric field generates waves at the interface of said drop, said generated waves being essentially axisymmetric.

Essentially axisymmetric means the waves are mainly or exclusively axisymmetric.

In this way, said axisymmetric waves generated by electrowetting on the triple line are propagated uniformly on the entire interface of the drop and induce a substantially homogeneous micro-mixture of the drop liquid.

The axisymmetric nature of the waves makes it possible to obtain a resonant mode in a defined zone at a distance from the triple line and the excitation electrode. It is then possible to obtain a potentially significant concentration in said zone of constituents potentially present at the interface, particularly larger constituents. As an illustration, in the case of semi-spherical drop, the resonant mode is obtained substantially at the apex (top) of the drop.

Furthermore, the concentration of constituents at the interface may be substantially homogeneous or increase on moving away from the wetting plane containing the triple line of the drop, depending on whether said axisymmetric waves are substantially stationary or progressive.

Advantageously, said waves formed have a substantially linear behaviour.

Preferentially, said waves have an amplitude to wavelength ratio between 10⁻⁵ and 1.

Preferentially, said waves have an amplitude to wavelength ratio between 10⁻⁵ and 10⁻¹.

Preferentially, said waves have an amplitude to wavelength ratio between 10⁻⁴ and 10⁻².

Preferentially, said waves have an amplitude to wavelength ratio of the order of 10⁻³.

Preferentially, said waves have an amplitude to drop radius ratio less than or equal to 10⁻¹, preferentially less than or equal to 10⁻², preferentially of the order of 10⁻³.

Drop radius means the radius of a semi-sphere substantially corresponding to said drop arranged on said excitation electrode without any generated wave at the interface, or the radius, called equivalent radius, of a sphere having the same volume of said drop.

According to a first embodiment of the invention, the device comprises a single excitation electrode having substantially a disk shape.

According to one alternative embodiment, the device comprises a single substantially annular excitation electrode.

According to a second embodiment of the invention, the device comprises a first substantially annular excitation electrode and a second excitation electrode forming a counter-electrode having substantially a disk shape surrounded by said first excitation electrode.

According to one alternative embodiment, the device comprises a first excitation electrode and a second excitation electrode forming a counter-electrode, each having substantially a semi-annular arranged facing one another.

According to one alternative embodiment, the device comprises a first excitation electrode and a second excitation electrode forming a counter-electrode, each having substantially a half-disk shape arranged facing one another.

The excitation electrode(s) may comprise an inner edge defining a substantially circular inner edge, the triple line of said drop, preferentially, substantially facing said inner edge.

The excitation electrode(s) may also comprise an outer edge defining a substantially circular outer edge, the triple line of said drop, preferentially, substantially facing said outer edge.

In the first embodiment of the invention, the device may comprise a voltage generator to apply a different electric potential to said excitation electrode to that of said drop.

In the second embodiment of the invention, the device may comprise a voltage generator to apply a difference in potential between the first excitation electrode and the counter-electrode.

Preferentially, said electric field induces a difference in electrowetting potential between the excitation electrode and said drop having a frequency between 10 Hz and 150 Hz.

Said difference in electrowetting potential may have an amplitude between 1V and 100V.

Preferentially, said difference in electrowetting potential has an amplitude between 1V and 50V.

Advantageously, the excitation electrode(s) are covered with a layer of dielectric material.

Advantageously, said dielectric layer is covered with a layer of hydrophobic material.

Advantageously, said dielectric layer is hydrophobic.

The device may comprise means for trapping the triple line of said drop.

The wave formation device may comprise, additionally, at least one secondary excitation electrode, located opposite, parallel with said excitation electrode, suitable for generating an oscillating and radial electric field about a third axis of symmetry coinciding substantially with said first axis of symmetry, under the effect of said electric control.

In this case, said drop may be a capillary bridge formed between said excitation electrode and said secondary excitation electrode.

The invention also relates to a device for analysing a drop of liquid comprising:

a device for forming waves according to any of the features described above,

means for the geometric characterisation of the waves formed, and

analysis means, connected to said geometric characterisation means, for analysing, on the basis of the geometric characterisation of the waves formed, the physical and/or chemical properties of said drop.

According to one alternative embodiment, the geometric characterisation means are means for measuring the amplitude of the waves formed.

The means for measuring the amplitude of the waves formed may be light absorption and/or interferometry measurement means.

According to another alternative embodiment, the geometric characterisation means are means for measuring the gradient of the waves formed along a line of the interface.

The means for measuring the gradient of the waves formed may be refractometry measurement means.

The geometric characterisation means may be both means for measuring the amplitude of the waves formed and means for measuring the gradient of the waves formed along a line of the interface.

According to another embodiment, the device for analysing a liquid drop comprises:

a device for forming waves according to any of the features described above,

means for the kinematic characterisation of the waves formed, and

analysis means, connected to said kinematic characterisation means, for analysing, on the basis of the kinematic characterisation of the waves formed, the physical and/or chemical properties of said drop.

The kinematic characterisation means may be means for measuring the normal velocity of the waves formed.

For the rheological analysis of the liquid drop, the geometric or kinematic wave characterisation makes it possible to determine the physicochemical properties of the liquid, particularly the interfacial properties thereof. For the detection of the constituents present, the amplitude or the gradient of the waves provides information on the constituents present, and makes it possible to obtain the kinetic parameters or the equilibrium constants associated with potential chemical interactions.

In this way, unlike the prior art, it is possible to do away with any optical or fluorescent probe grafting liable to disturb the chemical interactions or the physicochemical properties of the liquid.

Moreover, the detection techniques are easier to implement than in the prior art, while guaranteeing high precision. Optical techniques (refractometry, light absorption, interferometry, ellipsometry) may be used to perform the geometric or kinematic wave characterisation. Moreover, the axisymmetric nature of the waves makes it possible to obtain a resonance phenomenon in a zone of the interface at a distance from the triple line. The analysis means, on the basis of the geometric or kinematic wave characterisation, preferentially in said zone, are used to calculate the mechanical or physicochemical properties of the liquid, particularly the interfacial properties.

In this way, it is possible to perform a rapid real-time diagnosis given that the mixing, concentration and analysis steps may be performed simultaneously.

The analysis technique is non-intrusive, therefore there is no risk of physicochemical denaturing of the liquid sample, or disturbance of the potential molecular organization at the interface.

In this way, the device for analysing a liquid drop may analyse the chemical properties of the drop without labelling biological or chemical targets contained in the drop.

However, the device for analysing a liquid drop may additionally comprise means for measuring, at the interface of said drop, the concentration of labelled biological or chemical targets. In this way, the precision of the analysis is increased, due to the use of a plurality of chemical analysis methods.

According to another embodiment, the device for analysing a liquid drop comprises a wave formation device according to any of the features described above, and means for measuring, at the interface of said drop, the concentration of labelled biological or chemical targets.

Said targets may be labelled with a fluorescent or radioactive compound.

The invention also relates to a method for forming waves at the interface of a liquid drop by electrowetting, comprising the following steps:

arranging a liquid drop on at least one excitation electrode having a first axis of symmetry, such that the axis of symmetry of said drop coincides substantially with said first axis of symmetry, and

generating an oscillating and radial electric field about said first axis of symmetry, such that essentially axisymmetric waves are formed at the interface of said drop.

Said waves may have an amplitude to wavelength ratio between 10⁻⁵ and 1, preferentially between 10⁻⁵ and 10⁻¹, preferentially between 10⁻⁴ and 10⁻², preferentially of the order of 10⁻³.

Preferentially, said waves have an amplitude to drop radius ratio less than or equal to 10⁻¹, preferentially less than or equal to 10⁻², preferentially of the order of 10⁻³.

The invention also relates to a method for analysing a liquid drop, comprising the use of a wave formation method according to any of the features described above, a geometric characterisation step of said waves formed, and an analysis step of the physical and/or chemical properties of said drop, on the basis of the geometric characterisation of said waves formed.

The geometric characterisation step may be a measurement of the amplitude of the waves formed.

Preferentially, the measurement of the amplitude of said waves is performed in a defined zone of the interface at a substantial distance from the triple line of the drop.

Alternatively, the geometric characterisation step is a measurement of the gradient of the waves formed along a line of the interface.

The invention also relates to a method for analysing a liquid drop, comprising the use of a wave formation method according to any of the features described above, a kinematic characterisation step of said waves formed, and an analysis step of the physical and/or chemical properties of said drop, on the basis of the kinematic characterisation of said waves formed.

The kinematic characterisation step may be a measurement of the normal velocity of the waves formed.

The invention also relates to a method for analysing a liquid drop according to any of the features described above, comprising, additionally, a step for measuring, at the interface of said drop, the concentration of labelled biological or chemical targets.

The invention relates to a method for analysing a liquid drop, comprising the use of a wave formation method according to any of the above features, and a step for measuring, at the interface of said drop, the concentration of labelled biological or chemical targets.

Finally, the invention relates to the use of a wave formation device according to any of the above features, or an analysis device according to any of the above features, said liquid drop being a drop of blood.

Other advantages and features of the invention will emerge in the non-limitative detailed description below.

### BRIEF DESCRIPTION OF FIGURES

Embodiments of the invention will now be described as non-limitative examples, with reference to the appended figures, wherein:

FIGS. 1A and 1B are schematic longitudinal section representations of a device illustrating the principle of excitation of a liquid drop by means of electrowetting;

FIG. 2 is a schematic longitudinal section representation of a wave formation device according to a first embodiment of the invention comprising a single excitation electrode;

FIGS. 3A and 3B show a top view of different shapes of the excitation electrode according to the first embodiment;

FIG. 4 is a schematic longitudinal section representation of a wave formation device according to a second embodiment of the invention comprising an excitation electrode and a planar counter-electrode;

FIGS. 5A to 5C show a top view of different of excitation electrode and planar counter-electrode shapes;

FIG. 6 is a schematic longitudinal section representation of a wave formation device according to a third preferred embodiment of the invention comprising a capillary bridge; and

FIG. 7 is a schematic longitudinal section representation of a device for analysing a liquid drop, for measuring the amplitude of the waves formed.

### DETAILED DESCRIPTION OF A PREFERRED EMBODIMENT

A device according to the invention uses a liquid drop excitation device based on electrowetting, or more specifically, electrowetting on dielectric.

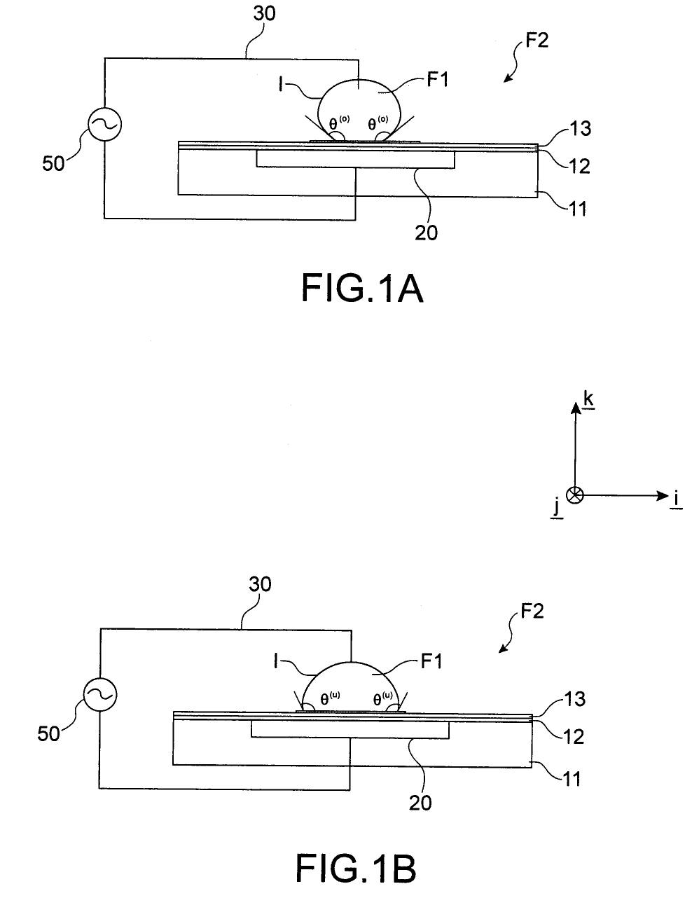

The principle of electrowetting on dielectric used within the scope of the invention may be illustrated using FIGS. 1A and 1B, as part of an open device.

A drop of an electrically conducting liquid F1 rests on an excitation electrode 20, from which it is isolated by a dielectric layer 12 and a hydrophobic layer 13. This gives a hydrophobic and insulating stack.

The hydrophobic nature of said layer 13 means that the drop F1 has a contact angle, on said layer, greater than 90°.

It is surrounded by a dielectric fluid F2, and forms an interface I with said fluid.

The excitation electrode 20 is formed on the surface of a substrate 11, or integrated therewith.

A counter-electrode 30, in this case in the form of a catenary wire, makes it possible to maintain electrical contact with the drop F1. Said counter-electrode 30 may also be an embedded wire or a planar electrode in the cowl of a confined system. However, it may likewise not be present.

The excitation electrode 20 and the counter-electrode 30 are connected to a voltage source 50 used to apply an electrowetting voltage U between the electrodes.

When the excitation electrode 20 is activated, i.e. in the case of electrical contact between said electrode 20 and the voltage source 50 via a conductive wire, the assembly consisting of the drop F1, dielectric layer 12 and activated electrode 20 acts as a capacitor.

As described in the article by Berge entitled “Electrocapillarité et mouillage de films isolants par l'eau”, C.R. Acad. Sci., 317, series 2, 1993, 157-163, the contact angle of the interface of the drop F1 decreases in this case according to the function:

$$cos {θ}^{( U )} = cos {θ}^{( 0 )} + \frac{1}{2} \frac{{ɛ}_{r}}{e σ} {U}^{2}$$

where e is the thickness of the dielectric layer 12, ∈ᵣ the permittivity of said layer and σ the surface tension of the drop interface.

If the electrowetting voltage is alternating, the liquid behaves like a conductor in that the polarisation voltage frequency is substantially less than a cutoff frequency, which is particularly dependent on the electrical conductivity of the liquid, and is typically of the order of a few dozen kilohertz (See for example the article by Mugele and Baret entitled “Electrowetting: from basics to applications”, J. Phys. Condens. Matter, 17 (2005), R705-R774). Moreover, the frequency may be substantially greater than the hydrodynamic response frequency of the liquid F1, which is dependent on the physical parameters of the drop such as the surface tension, the viscosity or size of the drop, and is the order of a few hundred hertz. In this case, the response of the drop F1 is dependent on the root mean square voltage value, since the contact angle is dependent on the voltage in U².

According to the article by Bavière et al. entitled “Dynamics of droplet transport induced by electrowetting actuation”, Microfluid Nanofluid, 4, 2008, 287-294, an electrostatic pressure appears acting on the interface I, in the vicinity of the contact line. The interface is deformed so as to observe the contact angle applied by electrowetting (FIG. 1B).

It should be noted that, in a manner known to those skilled in the art, the asymmetric application of said electrostatic pressure, using an excitation electrode network, induces the displacement of the drop F1. The drop may thus be optionally displaced by degrees on the hydrophobic surface, by successive activation of the excitation electrodes. Therefore, it is possible to displace liquids and perform complex protocols.

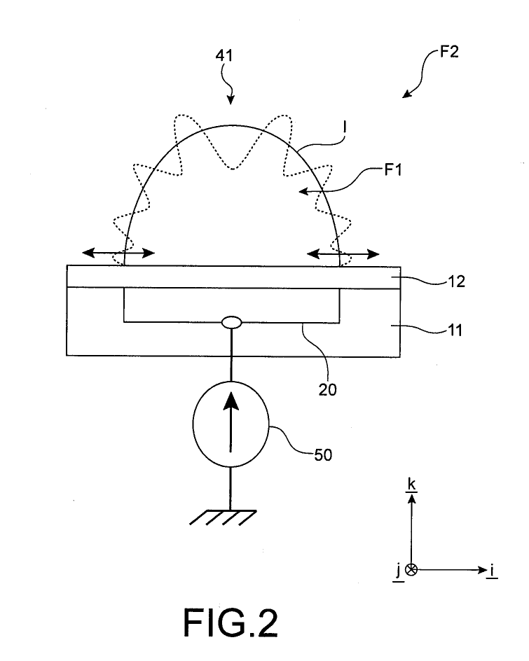

A wave formation device at the fluid interface of a liquid drop according to the first preferred embodiment of the invention is represented schematically in FIG. 2, as a longitudinal section.

The device comprises an excitation electrode 20 forming a plane and integrated in a first substrate 11.

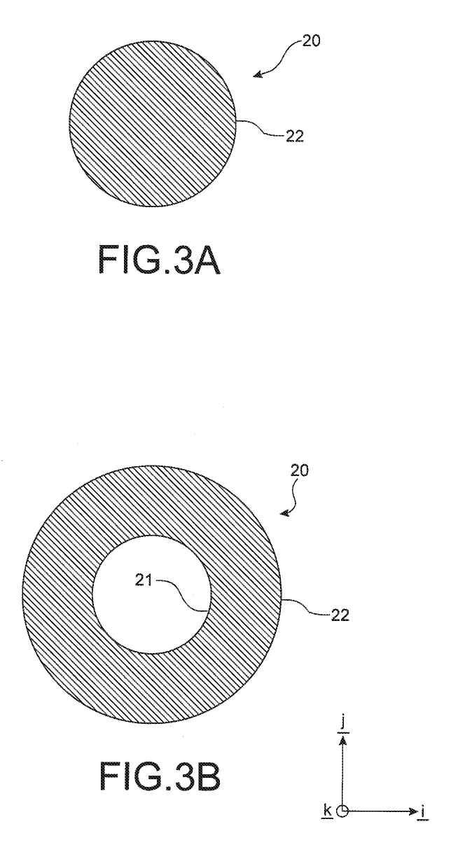

According to the first embodiment of the invention, the device comprises a single excitation electrode 20 substantially in the shape of a disk (FIG. 3A). A substantially annular shape is also possible, as described hereinafter with reference to FIG. 3B.

The plane containing the excitation electrode substantially parallel with the plane (i,j) of the direct orthonormed reference (i,j,k) is referred to as the median plane of the electrode.

Preferentially, the excitation electrode 20 is covered with a layer of dielectric material 12. Advantageously, said dielectric layer 12 is covered with a layer of hydrophobic material 13 (not shown).

The wave formation device comprises a liquid drop F1 in contact with the hydrophobic layer so as to coat the excitation electrode 20 at least partially.

As specified above, the term drop may refer to a substantially semi-spherical drop, pool or a capillary bridge. In the example represented in FIG. 2, the drop F1 is substantially semi-spherical, more specifically hemispherical.

In the description hereinafter, the verbs “cover” and “be arranged on” do not, in this case, necessarily imply direct contact with the excitation electrode. As described hereinafter, the drop may cover, or be arranged on the excitation electrode 20, without being in direct contact therewith, for example when a hydrophobic layer 13 and/or a dielectric layer 12 covers said electrode 20.

The term drop interface I refers to the fluid formed between the liquid of the drop F1 and a surrounding fluid F2.

The line of the drop in contact with the hydrophobic layer and belonging to the drop interface is referred to as the triple line. The triple line is preferentially substantially circular.

The interface forms a contact angle with the triple line plane, said angle being by convention measured in the drop liquid. When the drop is in contact with the hydrophobic layer, and in the absence of any electrostatic stress, the contact angle is substantially greater than 90°.

The drop may contain constituents in the volume and at the interface. The generic term of constituents refers to any species potentially present in the drop (macromolecules: DNA, RNA, proteins, cells, organites, actinides, colloids and solid particles, etc.). The term biological or chemical targets may also be used.

According to the invention, the excitation electrode 20 has a first axis of symmetry and the drop F1 has a second axis of symmetry which coincides substantially with the first axis. The first and second axes of symmetry are preferentially substantially perpendicular to the median plane.

In the example in FIG. 2, and with reference to FIG. 3A, the excitation electrode 20 comprises an edge 22 forming an outer edge. The outer edge is substantially circular, due to the axis of symmetry of the electrode.

As shown in FIG. 3A which is a top view of the excitation electrode, the drop is preferentially arranged so as to cover the excitation electrode 20 at least partially. The triple line is, preferentially, located substantially facing the outer edge.

The excitation electrode 20 is suitable for generating an oscillating and radial electric field about the first axis of symmetry. For this purpose, it may be connected to a voltage generator 50 which applies a substantially different potential to the electrode 20 to that of the drop F1. A so-called electrowetting difference in potential is then generated between the excitation electrode 20 and the drop F1.

The electrowetting voltage generated by the voltage generator 50 may comprise a first direct voltage or high frequency component V, and a so-called excitation voltage modulation v.

The excitation modulation is referenced v(ω) and has a frequency ω substantially less than the hydrodynamic response frequency of the drop. The frequency ω may be between 10 Hz and 500 Hz, and preferentially between 10 Hz and 150 Hz. The amplitude Aᵥ may be between 1V and 100V, and preferentially between 1V and 50V.

The low frequency modulation v(ω) enables harmonic modulation of the contact angle. Given that the frequency is less than the hydrodynamic response frequency, the contact angle variation substantially follows the amplitude and frequency of the modulation v. This may be referred to as oscillatory electrowetting.

The first component is referenced V and may be direct voltage, between 1V and a few hundred volts, for example 200V. Preferentially, it is of the order of a few dozen volts. It may also be a high frequency alternating voltage V(Ω) having a frequency Ω substantially greater than the hydrodynamic response frequency, for example between 500 Hz and 10 kHz, preferentially of the order of 1 kHz. This component is then viewed by the drop as a direct voltage having a value equal to the root mean square value of the voltage V, as the contact angle is dependent on the voltage in V², according to the function given above. The root mean square value may vary between 1V and a few hundred volts, for example 200V. Preferentially, it is of the order of a few dozen volts.

This component V makes it possible to apply a defined contact angle at the drop interface and therefore adjust the general shape thereof.

According to another embodiment, the voltage generator 50 may also generate a low frequency electrowetting voltage, which does not comprise a direct current or high frequency component V. In this case, the amplitude and frequency correspond to the values described for the excitation modulation v.

The excitation electrode 20 may be produced by depositing a thin layer of a metal selected from Au, Al, ITO, Pt, Cu, Cr, etc. or an Al—Si allow, etc. using conventional microelectronic techniques, for example by means of photolithography. The electrode 20 is then etched with a suitable pattern, for example by means of wet etching.

The thickness of the electrode 20 may be between 10 nm and 1 μm, preferentially 300 nm. The size thereof is dependent on the size of the drop F1 to be excited. It should preferentially be commensurable with the size of the drop.

A dielectric layer 12 may cover the excitation electrode 20. It may be made of Si₃N₄, SiO₂, SiN, barium strontium titanate (BST) or other high permittivity materials such as HFO₂, Al₂O₃, Ta₂O₅ [29], Ta₂O₅—TiO₂, SrTiO₃ or Ba1-xSrxTiO₃. The thickness of said layer 12 may be between 100 nm and 3 μm, as a general rule between 100 nm and 1 μm, preferentially 300 nm. The SiO₂ dielectric layer 12 may be obtained by means of thermal oxidation. A plasma-enhanced chemical vapour deposition (PECVD) method is preferred to the low-pressure chemical vapour deposition (LPCVD) method for temperature reasons. Indeed, the substrate temperature is only increased between 150° C. and 350° C. (depending on the desired properties) as opposed to approximately 750° C. for LPCVD deposition.

Finally, a hydrophobic layer 13 may be deposited on the dielectric layer 12. For this purpose, Teflon may be deposited by means of tempering, spin coating or spraying, or SiOC may be deposited by means of plasma. Vapour or liquid phase hydrophobic silane deposition may be performed. The thickness thereof is between 100 nm and 5 μm, preferentially 1 μm. Said layer 13 particularly makes it possible to reduce or prevent wetting angle hysteresis effects.

The drop liquid F1 is electrically conducting and may be an aqueous solution charged with ions, for example with Cl⁻, K⁺, Na⁺, Ca²⁺, Mg²⁺, Zn²⁺, Mn²⁺, and others. The liquid may also be mercury, Gallium, eutectic Gallium, or ionic liquids such as bmim PF₆, bmim BF₄ or tmba NTf₂.

The radius of the drop F1 may for example be between 10 microns and one centimetre, and is preferentially 1 mm.

The surrounding fluid F2 is, preferentially, insulating and may be air, a mineral oil or silicone, a perfluorinated solvent, such as FC-40 or FC-70, or an alkane.

The surrounding fluid F2 is non-miscible with the conductive drop liquid F1.

The operation of the device according to the first embodiment of the invention is as follows.

The voltage generator 50 applies a substantially different excitation electrode 20 to that of the drop F1. An electrowetting voltage U is then generated between the excitation electrode 20 and the drop F1. Due to the common symmetry of the excitation electrode 20 and the drop F1, the associated electric field is substantially perpendicular to the triple line, in the plane thereof.

Therefore, the electric field substantially has no tangential component, preventing any electrohydrodynamic or electrokinetic vortex formation phenomenon, such as, for example, the device according to the prior art.

The voltage modulation v induces a substantially isotropic contact angle along the triple line. The drop F1 is subject to substantially no displacement, particularly in the wetting plane. The electric field is this oscillating and radial about the axis of symmetry of the drop F1 and the excitation electrode 20.

The electric field then induces a variation of the contact angle and optionally an oscillating and radial displacement of the triple line about an equilibrium position.

The harmonic variation of the contact angle then generates an axisymmetric wave network at the interface I of the drop F1, from the triple line.

The waves are propagated uniformly at the interface, thus producing a substantially homogeneous micro-mixture of the drop liquid F1.

Due to the axisymmetric nature of the waves, a resonant mode is obtained at the apex 41 of the drop, i.e. in the zone substantially furthest from the drop. The amplitude is at the maximum thereof at the apex 41 and has a defined frequency.

Preferentially, the waves have an amplitude preferentially between 10 nm and 100 μm, preferentially 1 μm.

The wavelength may be such that the amplitude to wavelength ratio is between 10⁻⁵ and 1, preferentially between 10⁻⁴ and 10⁻², preferentially of the order of 10⁻³.

If the drop contains target constituents in the solubilised state, the interface I of the drop F1 may be functionalised so as to capture said constituents selectively. The device according to the invention then makes it possible to concentrate the constituents using the volume of the droplet at the interface thereof.

The concentration is significant at the apex 41 of the drop F1, and thus eliminates disturbances due to boundary conditions (triple line, hydrophobic layer wall).

The progressive component of the wave network may enable selective concentration of the constituents adsorbed at the interface I of the drop F1. It may transport the constituents to the apex 41 of the drop, differentially according to range of the molecular cross-section thereof. Here again, the concentration at the apex 41 is rendered significant.

The constituents not transported by the waves are liable to remain in the vicinity of the triple line. A separation, or purification, device of said constituents is used in this case. Specific extraction by ejecting droplets in an electric field or by forming and breaking a capillary bridge may enable the formation of two or a plurality of drops containing the separated constituents.

An alternative of the first embodiment of the invention relates to the shape of the excitation electrode 20.

In this way, as shown in FIG. 3B, the excitation electrode 20 may have an annular shape wherein the axis of symmetry coincides substantially with that of the drop F1.

In this case, the triple line may be located, in the absence of electrostatic stress, substantially facing the inner edge, or the outer edge, or between both edges.

The fact that the triple line is, when not under electrostatic stress, substantially facing the inner edge enables easy control of the spread of the drop under the effect of the electrowetting voltage.

Furthermore, the fact that the triple line is, when not under electrostatic stress, substantially facing the outer edge makes it possible to use same as a triple line trapping line.

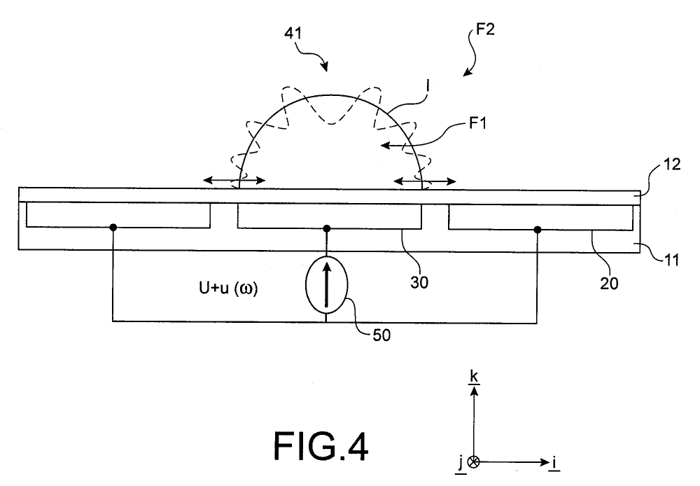

A second embodiment of the invention is represented in FIG. 4, wherein the device comprises a first excitation electrode 20, and a second excitation electrode 30 forming a counter-electrode.

Preferentially, the counter-electrode 30 is planar, integrated with said substrate 11, and within the median plane of the first excitation electrode 20.

FIG. 4 is a schematic longitudinal section representation of a device comprising an annular excitation electrode 20 surrounding the disk-shaped counter-electrode 30. Both electrodes 20, 30 have an axis of symmetry coinciding substantially with that of the drop.

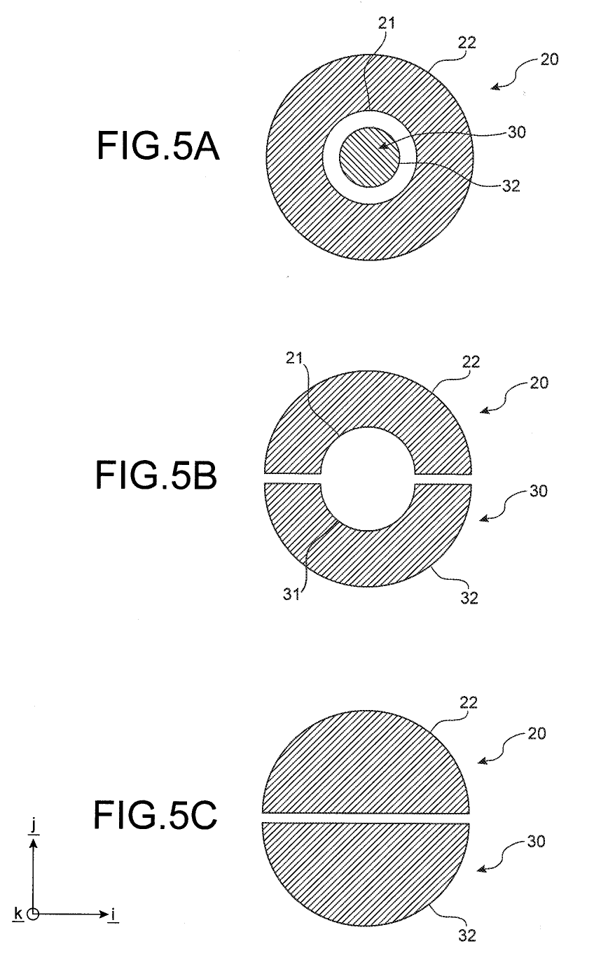

FIG. 5A is a top view of said electrodes. The spacing between the electrodes may be between 1 μm and 10 μm.

To generate an oscillating and radial electric field about the first axis of symmetry, a voltage generator 50 may apply a difference in potential to the electrodes 20, 30. This difference is potential makes it possible to generate a so-called electrowetting difference in potential between the electrodes 20, 30 and the drop F1.

The electrowetting voltage has the same features as in the first embodiment, which are therefore not described a second time here. The waves formed at the interface are also identical to that described above.

The triple line of the drop is, when not under electrostatic stress, preferentially located substantially facing the outer edge of the counter-electrode 30, the inner or outer edge of the excitation electrode 20.

If the annular electrode 20 has an outer edge 22 at a sufficient distance from the drop, said edge 22 may have any geometry, for example polygonal, provided the electric field at the triple line remains radial.

FIGS. 5B and 5C are top views of the first excitation electrode 20 and the second excitation electrode 30 forming the counter-electrode.

FIG. 5B illustrates semi-annular electrodes 20, 30 and FIG. 5C half-disk-shaped electrodes 20, 30. Each electrode is arranged facing the other, such that the electrical activation of the electrodes 20, 30 by the voltage generator 50 makes it possible to generate a radial electric field about the first axis of symmetry. The minimum spacing between the electrodes may be between 1 μm and 10 μm.

The operation and embodiment of the device according to the second embodiment are the same as described above.

The advantage of using a second excitation electrode 30 forming a counter-electrode consists of setting the potential of the drop to a substantially equidistant value from the potentials of both electrodes 20, 30. The electrowetting voltage is thus better defined than in the first embodiment wherein the drop F1 has a floating potential.

It should be noted that the dielectric layer 12 is not essential for the electrowetting phenomenon. Indeed, in the absence of a dielectric layer 12, the drop F1 is in electric contact with the excitation electrode 20. When the electrode 20 is activated, a double electric layer is formed in the drop on the surface of the electrode 20 and forms a dielectric layer wherein the thickness is of the order of magnitude of the Debye length (a few dozen nanometres). The electrowetting voltage applied remains advantageously low so as to prevent electrochemical phenomena such as water electrolysis.

Furthermore, it is advantageous to increase the hydrophobicity of the solid layer supporting the drop, to favour the slip of the triple line and limit viscous dissipation. For this purpose, thiols may be grafted onto the solid layer in question.

It may be advantageous, on the other hand, to trap the triple line to limit the displacement thereof and the associated viscous dissipation. For this, the triple line, may be trapped by a ring-shaped roughness etched in the solid substrate. In this case, the waves are not formed by the oscillating and radial displacement of the triple line but by the harmonic variation of the contact angle.

It should also be noted that the device according to the invention has the advantage of not requiring a counter-electrode arranged in direct electric contact with the drop, for example in the form of a suspended wire. In this way, the electric field remains perpendicular to the triple line. Therefore, the waves formed are axisymmetric, thus eliminating any disturbance of the axis of symmetry due to the presence of the counter-electrode. This also enables easier production and integration in existing laboratories on a chip. Furthermore, a counter-electrode in direct contact with the drop, for example in the form of a suspended wire, may disturb the concentration of the constituents at the interface.

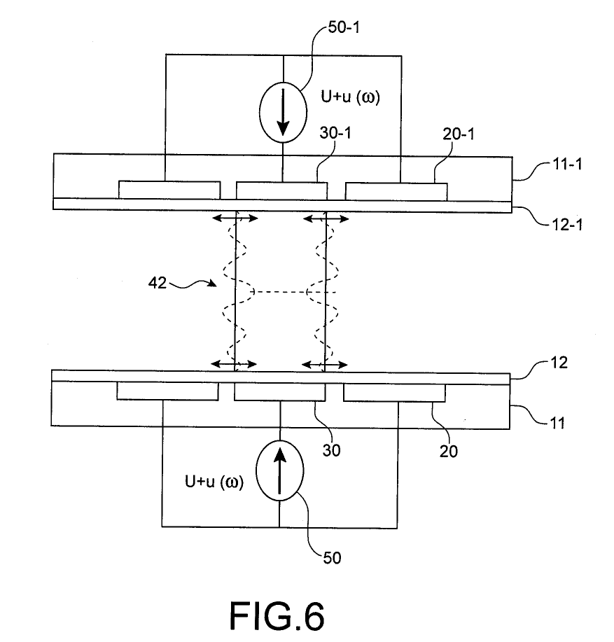

FIG. 6 is a schematic longitudinal representation of the device according to a third embodiment of the invention.

The device no longer comprises a single plane substrate 11, but also a second substrate 11-1, arranged facing the first 11 and substantially parallel therewith.

The second substrate 11-1 also comprises at least one excitation electrode 20-1, 30-1, opposite that 20, 30 of the first substrate. A hydrophobic layer and a dielectric layer 12-1 may also be envisaged.

A drop F1 may be sandwiched between the two substrates so as to form a capillary bridge. The lower 20, 30 and upper 20-1, 30-1 excitation electrodes are connected to the voltage generator 50, or as represented in FIG. 6, to a second voltage generator 50-1 synchronous with the first 50.

In this way, the activation of the electrodes makes it possible to generate waves according to the same features as above. The resonant mode is in this case formed on the central section 42 of the capillary bridge.

The constituents may thus be transported to the central section 42 of the liquid bridge, differentially according to the range of the molecular cross-section thereof. The device is used in this case to perform the concentration of the constituents of the interface at the interface line of the central section 42 of the capillary bridge.

The constituents not transported by the waves are liable to remain in the vicinity of the lower and upper triple lines. In this case, a device for separating, or purifying, these constituents is used. A specific extraction by breaking the capillary bridge may be performed by means of relative distancing of the first and second substrates from each other, or by amplifying the electrowetting voltage.

The device according to the third embodiment has an operation and embodiment that are substantially similar to those described in the first and second embodiments.

The invention also relates to an analysis device comprising a device for forming waves at the interface of a drop according to any of the embodiments described above.

The analysis of the drop may be performed for the purposes of rheological analysis, to measure the surface tension, dynamic viscosity, interfacial viscosity and elasticity, etc. It may also be used for the real-time detection of interfacial ageing and thus the target constituent concentration.

The device for analysing a liquid drop, according to a first embodiment, comprises a wave formation device as described above, means for the geometric characterisation of the waves formed, and analysis means, connected to said geometric characterisation means, for analysing, on the basis of the geometric characterisation of the waves formed, the physical and/or chemical properties of said drop F1.

According to a first alternative embodiment, the geometric characterisation means are means for measuring the amplitude of the waves formed, for example, by means of light absorption and/or interferometry.

The amplitude measurement is preferentially local, in the interfacial zone of the resonant mode, i.e. on the apex 41 for a semi-spherical drop, and on the central section 42 of a capillary bridge.

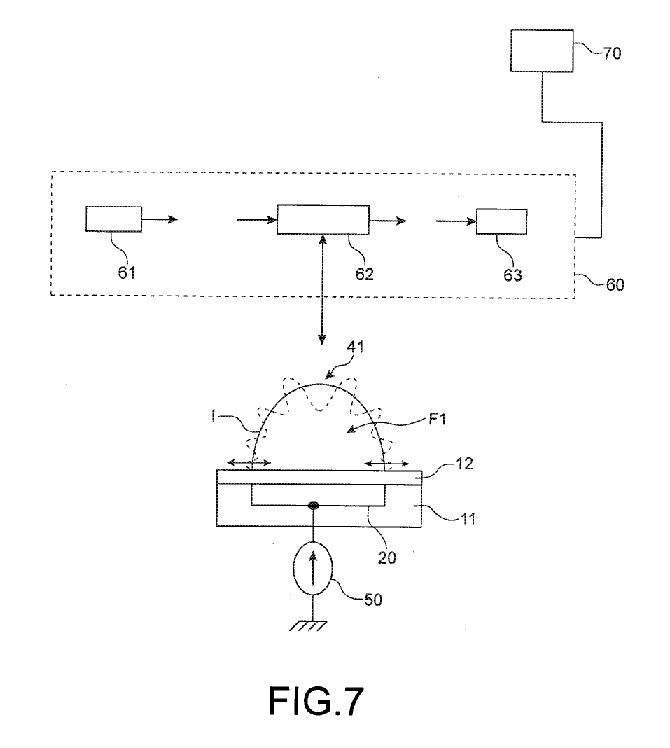

FIG. 7 gives an example of an analysis device with amplitude measurement, in this case on the apex of a semi-spherical drop.

The amplitude measurement is preferentially located in the zone of the resonant mode 41. Indeed, the resonant nature of the waves is particularly sensitive to the presence of concentrated constituents at the interface. In this way, as the interface is enriched with constituents, slippage of the resonance frequency may be observed. This behaviour may be measured in real time during the interfacial ageing process, or by means of a comparison between an initial stationary chemical state of the interface and a final stationary state, after concentration at the interface.

The linear behaviour of the waves, i.e. having a very low amplitude to wavelength ratio between 10⁻⁵ and 1, preferentially between 10⁻⁴ and 10⁻², or of the order of 10⁻³, makes it possible to associate the resonance frequency with the rheological properties of the interface by means of a dispersion function. Furthermore, the dynamic surface tension is dependent on the constituent concentration value at the interface.

Also, measuring the amplitude at the apex 41 of the drop F1 makes it possible to obtain, using analysis means, the resonance frequency and thus the rheological and physicochemical properties of the liquid from the drop.

The light absorption technique (not shown) may also be used, to measure the height of the drop. In this detection mode, a light source transmits a beam which passes through the drop. This beam is reflected onto the electrode 20, passes through the drop in the opposite direction and is collected by an optical system and sent to a detector. The beam may also be transmitted via the drop and the substrate, the latter being transparent to the incident wavelength, and then detected. The signal measured by the detector is given by the Beer-Lambert law. Therefore, it is inversely proportional to the liquid height. The light source may be a laser or a light-emitting diode (LED). The detector may be a photodiode, a camera or any other light-sensitive device. This absorption measurement is closely dependent on the presence of biological species. It is advantageous to standardize the height measurements when drop oscillates with the drop height in the resting state. This enables a differential measurement that is more sensitive than absolute measurements.

It advantageous to use the interferometry technique for the real-time measurement of the amplitude of the waves of the interface at the apex 41 of the drop. It offers the advantage of being easy to integrate on a laboratory on a chip. The measurement precision is finer than that of other optical techniques and the measurement can be used more rapidly as only one analogue signal needs to be processed.

The principle of the interferometric technique is shown in FIG. 7 in the example of a hemi-spherical drop.

Part of a laser beam, output by a source 61, is routed by a network 62, which may be a fibre network, to the apex 41 of the drop whereas the other part of directed to a photodetector 63. After partial reflection to the interface I of the drop F1, the beam is rerouted to the photodetector 63 whereon it interferes with the first beam. A network of interference fringes appears and when the drop interface is moved, the fringes are displaced. The photodetector 63 conveys this fringe displacement with a variation in intensity, the progression whereof over time induces a frequency-modulated signal. The progression of the instantaneous frequency over time conveys the displacement of the apex 41 of the drop (processing of the time-frequency type signal or by identifying an interferometric model). The minimum displacement threshold of the drop apex 41 may be one half-wavelength, i.e. approximately 300 nm for an HeNe laser transmitting in the red range. Due to the easy use thereof, this optical technique enables easy integration in laboratories on a chip.

The light source 61 is preferentially coherent. In one embodiment of the invention, the light source 61 is a laser diode, for reasons based on compact design, cost and integration. Liquid height measurements are more specific at short wavelengths, but lasers are less compact and more expensive. Therefore, red and near infrared wavelengths are preferred.

In the case of measurements combined with fluorescence, the laser is selected according to the absorption wavelengths of the fluorophores present in or at the drop interface.

The light source 61 may optionally be heat-regulated so as to output the most constant power possible. The power thereof may also be monitored continuously and adapted so as to correct the effects of some parameters liable to disturb the measurement (temperature, drop height in the resting state, optical index of fluid, etc.)

The separator 62 may consist of a plurality of elements:

a 1-to-2 coupler (Y, splitter) which splits the laser beam into two adjustable respective amplitude channels;

a 2-to-1 coupler (Y, concentrator), when sends the laser beam to the drop and collects the reflection on the interface to send it to the last part of the device;

a focussing device outputting the light from the laser on the drop and collecting the reflection on the upper surface. This device may consist of a split fibre head, a lens fibre, a microlens, or a selfoc (if a plurality of drops were to be analysed simultaneously); and

a 2-to-1 coupler (Y, concentrator), which concentrates in the same fibre, the beam coming directly from the laser and that from the reflection on the drop.

The Y couplers mentioned above may be fibre-optic couplers or microprisms.

The resulting beam is then sent to the photodetector 63.

The photodetector 63 is used to measure interferences and may be any type of light-sensitive device (photodiode, camera, avalanche photodiode (APD) etc.). A filter transmitting only the wavelength of the laser may optionally be placed in front of the photodetector 63 so as to limit light interference outside the device (ambient light). The coupling between the fibre, if a fibre is present, and the photodetector 63 may be performed by means of gluing, taping, or by means of an optical device (particularly if it is desired to place a filter in front of the photodetector).

The interferometry amplitude measurement technique offers a number of advantages:

Very easy integration. A drop displaced by means of electrowetting can readily be centered on any of the devices according to the invention, and arranged such that the vertical axis of symmetry thereof is aligned with an optical fibre for in situ detection purposes;

The high sensitivity of an interferometric sensor;

The robustness of an optical technique;

Absolute measurement without calibration; and

The option of using synchronous detection to increase the signal-to-noise ratio.

The means for measuring the amplitude 60 are connected to the analysis means 70, for example arranged on a printed circuit (not shown), which make it possible to analyse the amplitude measured to extract the resonance frequency therefrom, and thus deduce the microrheological or physicochemical properties of the drop.

Obviously, the measurement and analysis means may be used on a drop which forms a capillary bridge. In this case, the measurement is made preferentially at a point of the central section of the capillary bridge, the zone of the resonant mode interface.

According to a second alternative embodiment, the geometric characterisation means are means for measuring the gradient of the waves formed along a line of the interface, for example by means of refractometry.

The known method of refractometry (not shown) enables a gradient measurement along a line of the interface, in static or dynamic mode. It is preferable to apply this method along a long line of the interface, for example a line within a plane passing through the center and the apex of the drop, or, in the case of a capillary bridge, in a plane passing through the central section of said capillary bridge.

As for the amplitude measurement, the gradient measurement makes it possible to obtain, using the analysis means, the rheological and/or physicochemical properties of the drop liquid.

Obviously, the geometric characterisation means may comprise, both means for measuring the amplitude of the waves formed and means for measuring the gradient of the waves formed along a line of the interface, as described above.

According to a second embodiment, the device for analysing a liquid drop comprises a wave formation device according to any of the embodiments described above, kinematic characterisation means of the waves formed, and analysis means, connected to said kinematic characterisation means, to analyse, on the basis of the kinematic characterisation of the waves formed, the physical and/or chemical properties of said drop F1.

The kinematic characterisation means may be means for measuring the normal velocity of the waves formed, which may be similar to those for measuring the amplitude by means of interferometry, as described above. Indeed, the publication by Davoust et al. entitled “Detection of waves at an interface by way of an optical fibre” Progr. Colloid Polym. Sci. (2000), 115, 249-254, demonstrates that these measurement means make it possible to obtain both the amplitude at the desired point and the normal velocity.

The chemical properties of the drop may thus be analysed without labelling biological or chemical targets.

It may additionally comprise means for measuring, at the interface of said drop, the concentration of biological or chemical targets labelled with a fluorescent or radioactive compound.

These means for measuring the concentration may comprise a detector for measuring a radiation, for example a photon radiation. In the latter case, the photodetector may be an imager, an avalanche photodiode, a confocal microscope.

Alternatively, the device for analysing a liquid drop may not comprise means for characterizing the waves formed, but means for measuring, at the interface of said drop, the concentration of labelled biological or chemical targets. The wave formation makes it possible to mix the drop liquid, or also perform an optionally selective concentration of biological or chemical targets in a defined zone of the interface, such as the apex of a drop, or the central section of a capillary bridge.

Finally, it is possible to use the wave formation device as described above, to form waves on the surface of a drop of blood.

Furthermore, the device for analysing a liquid drop as described above, said liquid being blood, may be advantageously used to estimate the coagulation time.

Measuring the coagulation time is relevant for platelet disorders or haemophiliacs, but also and above all for transplant patients treated with anticoagulants.

The exact dosage of this treatment requires regular measurements which are usually performed using macroscopic installations in analysis laboratories.

The use of the analysis device according to the invention would make it possible to save considerable time and money.

Coagulation (secondary haemostasis) is activated by a polymerisation reaction following a complex cascade of coagulation factors.

This polymerisation consists of converting fibrinogen, a protein contained in blood plasma, into polymerized fibrin, creating a clot.

The conventional time scale for this process is of the order of a few minutes.

The polymerisation reaction induces an increase by several orders of magnitude of the dynamic viscosity in the drop.

The oscillations on the surface thereof are dependent on both the interfacial properties and the volume properties of the drop.

Continuous measurement using an optical technique, for example, of the amplitude of these oscillations may thus provide information on a time damping ratio particularly close to the coagulation time.

In this way, the device for analysing a drop of blood makes it possible to obtain the coagulation time in a particularly rapid and inexpensive manner.

The invention also relates to a method for forming waves at the interface of a liquid drop by electrowetting, comprising the following steps:

arranging a liquid drop F1 on at least one excitation electrode 20 having a first axis of symmetry, such that the axis of symmetry of said drop F1 coincides substantially with said first axis of symmetry, and

generating an oscillating and radial electric field about said first axis of symmetry, such that essentially axisymmetric waves are formed at the interface I of said drop F1.

Said waves preferentially have an amplitude to wavelength ratio between 10⁻⁵ and 1, and advantageously equal to 10⁻³.

Preferentially, said waves have an amplitude to drop radius ratio less than or equal to 10⁻¹, preferentially less than or equal to 10⁻², preferentially of the order of 10⁻³.

The invention also relates to a method for analysing a liquid drop, comprising the use of a wave formation method according to any of the features described above, a geometric characterisation step of said waves formed, and an analysis step of the physical and/or chemical properties of said drop, on the basis of the geometric characterisation of said waves formed.

As for the analysis device, the geometric characterisation step may be a measurement of the amplitude of the waves formed, or a measurement of the gradient of the waves formed along a line of the interface.

Preferentially, the measurement of the amplitude of said waves is performed in a defined zone of the interface at a substantial distance from the triple line of the drop, for example at the apex of a hemispherical drop, or in the central section of a capillary bridge.

The gradient may be measured along a line contained in a plane passing through the apex and the center of a hemispherical drop, or in a plane containing the central section of a capillary bridge.

The invention also relates to a method for analysing a liquid drop, comprising the use of a wave formation method according to any of the features described above, a kinematic characterisation step of said waves formed, and an analysis step of the physical and/or chemical properties of said drop, on the basis of the kinematic characterisation of said waves formed.

The kinematic characterisation step may be a measurement of the normal velocity of the waves formed, as described above.

The method for analysing a liquid drop may comprise, additionally, a step for measuring, at the interface of said drop, the concentration of labelled biological or chemical targets.

The invention also relates to a method for analysing a liquid drop, comprising the use of a wave formation method according to any of the above features, and a step for measuring, at the interface of said drop, the concentration of labelled biological or chemical targets.

1. Device for forming waves at the interface (I) of a liquid drop (F1) by electrowetting, characterized in that it comprises:
at least one excitation electrode suitable for generating an oscillating and radial electric field about a first axis of symmetry, under the effect of an electric control, so that, in the presence of a liquid drop (F1) arranged on said excitation electrode and having an axis of symmetry coinciding substantially with said first axis of symmetry, said electric field generates waves at the interface (I) of said drop (F1), said generated waves being essentially axisymmetric.

2. Device for forming waves according to claim 1, characterized in that said waves have an amplitude to wavelength ratio between 10⁻⁵ and 10⁻¹, and/or an amplitude to drop radius less than or equal to 10⁻¹.

3. Device for forming waves according to claim 1, characterized in that it comprises a single excitation electrode having substantially a disk shape.

4. Device for forming waves according to claim 1, characterized in that it comprises a single excitation electrode having substantially an annular shape.

5. Device for forming waves according to claim 1, characterized in that it comprises a first annular excitation electrode and a second excitation electrode forming a counter-electrode having substantially a disk shape surrounded by said first excitation electrode.

6. Device for forming waves according to claim 1, characterized in that it comprises a first excitation electrode and a second excitation electrode forming a counter-electrode, each having substantially a semi-annular shape arranged facing one another.

7. Device for forming waves according to claim 1, characterized in that it comprises a first excitation electrode and a second excitation electrode forming a counter-electrode, each having substantially a half-disk shape arranged facing one another.

8. Device for forming waves according to claim 1, characterized in that the excitation electrode(s) comprises an inner edge defining a substantially circular inner edge, the triple line of said drop being, preferentially, substantially facing said inner edge.

9. Device for forming waves according to claim 1, characterized in that the excitation electrode(s) comprises an outer edge defining a substantially circular outer edge, the triple line of said drop substantially facing said outer edge.

10. Device for forming waves according to claim 1, characterized in that said electric field induces a difference in electrowetting potential between the excitation electrode and said drop (F1) having a frequency between 10 Hz and 150 Hz.

11. Device for forming waves according to claim 10, characterized in that said difference in electrowetting potential has an amplitude between 1V and 100V.

12. Device for forming waves according to claim 1, characterized in that it comprises means for trapping the triple line of said drop (F1).

13. Device for forming waves according to claim 1, characterized in that it comprises, additionally, at least one secondary excitation electrode (20-1), located opposite, parallel with said excitation electrode, suitable for generating an oscillating and radial electric field about a third axis of symmetry coinciding substantially with said first axis of symmetry, under the effect of said electric control.

14. Device for forming waves according to claim 13, characterized in that said drop (F1) is a capillary bridge formed between said excitation electrode and said secondary excitation electrode (20-1).

15. Device for analysing a liquid drop, characterized in that it comprises:
a device for forming waves according to claim 1,
means for the geometric or kinematic characterisation of the waves formed, and
analysis means, connected to said characterisation means, for analysing, on the basis of the characterisation of the waves formed, the physical and/or chemical properties of said drop (F1).

16. Device for analysing a liquid drop according to claim 15, characterized in that the geometric characterisation means are means for measuring the amplitude of the waves formed, and/or means for measuring the gradient of the waves formed along a line of the interface.

17. Device for analysing a liquid drop according to claim 16, characterized in that the kinematic characterisation means are means for measuring the normal velocity of the waves formed.

18. Device for analysing a liquid drop, characterized in that it comprises:
a device for forming waves according to claim 1,
means for measuring, at the interface of said drop, the concentration of labelled biological or chemical targets.

19. Method for forming waves at the interface of a liquid drop by electrowetting, characterized in that it comprises the following steps:
arranging a liquid drop (F1) on at least one excitation electrode having a first axis of symmetry, such that the axis of symmetry of said drop (F1) coincides substantially with said first axis of symmetry, and
generating an oscillating and radial electric field about said first axis of symmetry, such that essentially axisymmetric waves are formed at the interface (I) of said drop (F1).

20. Method for forming waves according to claim 19, characterized in that said waves have an amplitude to wavelength ratio between 10⁻⁵ and 10⁻¹, and/or an amplitude to drop radius ratio less than or equal to 10⁻¹.

21. Method for analysing a liquid drop, comprising the use of a method for forming waves according to claim 19, a geometric or kinematic characterisation step of said waves formed, followed by a step for analysing the physical and/or chemical properties of said drop, on the basis of the geometric characterisation of said waves formed.

22. Method for analysing a liquid drop, comprising the use of a method for forming waves according to claim 19, and a step for measuring, at the interface of said drop, the concentration of labelled biological or chemical targets.
